(19) United States
(12) Patent Application Publication
(10) Pub. No.: US 2004/0156186 A1
(43) Pub. Date: Aug. 12, 2004

(54) Luminescent push-button or switch

(75) Inventors: Wolfgang Bredow, Niefern-Oschelbronn (DE); Thomas Burchard, Pforzheim (DE); Thomas Haug, Olbronn (DE)

Correspondence Address: BROWDY AND NEIMARK, P.L.L.C., 624 NINTH STREET, NW, SUITE 300, WASHINGTON, DC, 20001-5303, US

(73) Assignee: Integrated Electronic Systems !SYS Consulting GmbH, Olbronn-Durm (DE)

(21) Appl. No.: 10/771,297

(22) Filed: Feb. 5, 2004

(30) Foreign Application Priority Data
Feb. 6, 2003 (DE) DE 103 04 690.9

(51) Int. Cl. F21V 9/16

(52) U.S. Cl. 362/84

(57) ABSTRACT

A control element for a device, specifically a push-button or switch, is provided on at least part of its visible surface with a luminescent substance, which is admixed to the synthetic material of the control element. The luminescent substance provides, over a certain period of time, a luminous density with decreasing intensity, which compared to areas in the vicinity and/or applied symbols, produces an at least sufficiently visible contrast in order to make the control element stand out recognizably.

### BACKGROUND OF THE INVENTION

The present invention is concerned with a control element such as a push-button or switch.

Devices of many different types, especially electric or electronic devices, require the operation of control elements in order to function as intended, i.e., the control elements must be moved into a specific position to bring about a defined function of the device, be it, for example, by rotation through a certain angle, or through operation by pressure.

The proper functioning of the device depends on the recognizability or visibility of the various control elements. This is of additional importance, especially if the device to be operated is a device with which safety-relevant processes are controlled, such as, e.g., a remote control device in industrial remote control systems, where erroneous operation could possibly cause substantial damage. This case may arise, for example, if a sudden power outage causes an illuminated room to suddenly plunge into darkness; the safe operation of the electronic device must remain ensured even in such a case.

It is known in various fields to use flat component parts, for example in the form of films, to achieve the stated purpose. German patent document DE 44 21 942 C2, for example, shows a panel that can be illuminated and to which, in the interior of an automobile, a luminescent film is attached. German patent document DE 202 01 224 U1 shows a sign wherein, for purposes of the recognizability of symbols, an electrically activatable luminescent film is disposed, which illuminates areas of high transparency of a symbol carrier from behind and therefore makes the conveyed meanings of the symbols recognizable. This application is particularly suitable for automobile license plates.

The known solutions have in common that they either require a power supply in order to achieve a lasting luminescent effect, or that they are based purely on reflection. Both solutions cannot eliminate the problems described above.

### BRIEF SUMMARY OF THE INVENTION

The invention improves such a control element in a way that it remains recognizable in the event of sudden darkness, for a sufficient amount of time and without special provisions or operating processes, at least to such a degree that the continued operation of the device remains ensured during that time.

According to the invention, there is provided a control element for a device, the control element having a visible surface and a luminescent paint covering at least part of the visible surface. Preferably, the control element is a push-button or a switch

The underlying idea of the invention must be seen in that the synthetic material of at least a section of the control element has admixed to it or placed thereon a luminescent substance that continues to produce light after external illumination has ended, which, due to electro-chemical processes, provides a luminous density for a certain amount of time with decreasing intensity and which, compared to areas in the vicinity and/or applied control symbols, produces an at least sufficiently visible contrast in order to make the control element stand out recognizably.

### BRIEF DESCRIPTION OF THE DRAWINGS

FIGS. 1A and 1B are, respectively, a cross-sectional view and a plan view of an embodiment of the invention.

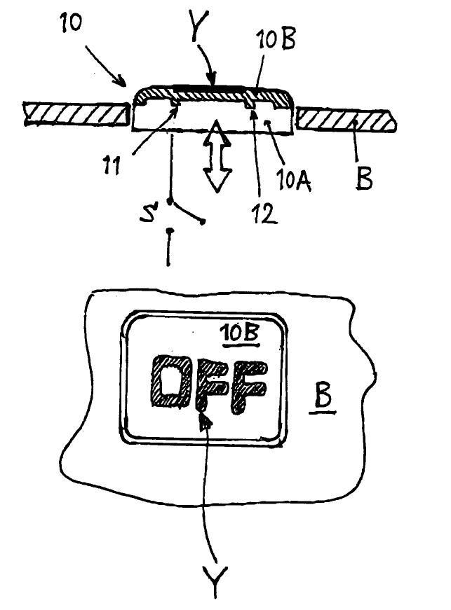

### DETAILED DESCRIPTION OF THE INVENTION

In the depicted embodiment, a control panel B of a device, such as, e.g., an electric or electronic device, is presented, wherein a control element 10, in this case a push-button, can be vertically shifted in the direction of the double arrow and triggers a switching process that is symbolically characterized here by a switch S. The implementation of the translation of the switching movement of the control element into a corresponding switching process is already well known in many ways and is not an object of the present invention.

Control element 10 consists of a carrier element 10A and a luminescent element 10B covering element 10A. Element 10B is accurately positioned on carrier element 10A by contours and corresponding recesses. For example, in the illustrated embodiment, element 10B is provided with pegs 11, 12 and element 10A is provided with matching recesses, which assures accurate positioning. Element 10B is secured in position on element 10A by adhesion, for example. In the illustrated embodiment, element 10B has a downwardly extending peripheral rim and element 10A has a corresponding peripheral notch that receives the rim.

luminescent element 10B is made of a synthetic material that has admixed to it or contains a luminescent substance, such as a paint that is commercially available, for example under the brand name “DualGlo” by the firm Color Service GmbH. These luminescent paints feature a day-glow effect, as well as an afterglow effect, and the duration of the afterglow, or the persistence of light emission, can last at least 8 to 10 hours.

This paint additive is preferably admixed to a thermoplastic and processed together with the thermoplastic in an injection molding process, with the portion of the luminescent paint in the mixture being approximately around 10% to 20%. The selected percentage determines especially also the intensity of the luminescent effect without significantly impairing the mechanical properties of the utilized polymer.

If necessary, a symbol Y, which neutralizes or masks the luminescent effect, is applied onto the upper side of carrier element 10A, so that a sufficient contrast effect is produced to ensure the visibility of the symbol relative to the (after)glowing background of the remaining surface area of carrier element 10A. A preferred option for neutralizing the luminescent effect is the application of laser radiation of suitable energy density and in the pattern of the symbol on the upper side of the carrier element. The symbol may be one or more words, letters, numbers, icons, etc.

The invention has been described above in connection with the control area of an electric/electronic device. However, it goes without saying that it can be also utilized anywhere where the problem that was described at the beginning of this specification exists, i.e, where the visibility of the control element must remain ensured at least for a minimum amount of time if the lights should go out.

This application relates to subject matter disclosed in German Application Number 103 04 690.9, filed on Feb. 6, 2003, the disclosure of which is incorporated herein by reference.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A control element for a device, said control element having a visible surface and comprising a luminescent substance covering at least part of said visible surface.

2. The control element of claim 1, wherein said control element is a push-button or switch.

3. The control element of claim 1, comprising an body of synthetic material containing the luminescent substance as an additive.

4. The control element of claim 3, wherein said synthetic material is a thermoplastic.

5. The control element of claim 4, wherein said luminescent substance is a paint.

6. The control element of claim 3, wherein said luminescent substance is a paint.

7. The control element of claim 1, comprising a carrier element and a luminescent element containing said luminescent substance and at least partially covering said carrier element.

8. The control element of claim 7, wherein said luminescent element and said carrier element are shaped to interfit with one another.

9. The control element of claim 8, wherein said luminescent element has a form of a lid.

10. The control element of claim 9, wherein said luminescent element and said carrier element have corresponding contours and matching recesses for accurate positioning.

11. The control element of claim 10, wherein said contours are constituted by pegs.

12. The control element of claim 8, wherein said luminescent element and said carrier element have corresponding contours and matching recesses for accurate positioning.

13. The control element of claim 12, wherein said contours are constituted by pegs.

14. The control element of claim 7, wherein carrier element and luminescent element are joined to one another by adhesion.

15. The control element of claim 14, wherein said luminescent element and said carrier element are shaped to interfit with one another.

16. The control element of claim 15, wherein said luminescent element has a form of a lid.

17. The control element of claim 16, wherein said luminescent element and said carrier element have corresponding contours and matching recesses for accurate positioning.

18. The control element of claim 17, wherein said contours are constituted by pegs.

19. The control element of claim 1, wherein said control element has a visible surface provided with at least one symbol that is applied to said surface and covers or neutralizes said luminescent substance.

20. An electric or electronic device comprising at least one control element according to claim 1.
